(19) United States
(12) Patent Application Publication
(10) Pub. No.: US 2024/0196502 A1
(43) Pub. Date: Jun. 13, 2024

(54) NEAR FIELD COMMUNICATIONS ENABLED DIMMING CIRCUIT

(71) Applicant: ABL IP Holding, LLC, Atlanta, GA (US)

(72) Inventors: Feng CHEN, Hoffman Estates, IL (US); Towfiq M. CHOWDHURY, Lake Forest, IL (US)

(21) Appl. No.: 18/534,296

(22) Filed: Dec. 8, 2023

Related U.S. Application Data
(60) Provisional application No. 63/386,519, filed on Dec. 8, 2022.

(51) Int. Cl. H05B 47/19; H05B 45/10; H05B 45/20

(52) U.S. Cl. CPC H05B 47/19; H05B 45/10; H05B 45/20

(57) ABSTRACT

In an approach to control of a lighting device using Near Field Communications (NFC), a device includes a near field communication (NFC) circuit configured to communicate via a radio frequency (RF) control signal and a controller. The controller is configured to: receive input control signals from a user via the NFC circuit; and send lighting control signals to a lighting device based on the input control signals.

### CROSS REFERENCE TO RELATED APPLICATIONS

This application claims the benefit of U.S. Provisional Application Ser. No. 63/386,519, filed 8 Dec. 2022, which is hereby incorporated by reference in its entirety.

### FIELD

The present application relates generally to lighting devices and, more particularly, to control of a lighting device using Near Field Communications (NFC).

### BACKGROUND

LED-based lighting devices are typically designed to run on low voltage (12-24V), direct current (DC) electricity. However, electricity is typically supplied in higher voltage (e.g., 120-277V), alternating current (AC) electricity. To run LEDs off the typical AC supply voltage, an LED driver is used. An LED driver is basically a power supply whose main purpose is to rectify higher voltage AC to low voltage DC. LED drivers also protect the LEDs from fluctuations in voltage or current. LED light output is proportional to the supplied current, and LEDs are rated to operate within a certain current range. Too much or too little current can therefore cause light output to vary or degrade faster due to higher temperatures within the LED.

The LED driver, or power supply, is a component for LED lighting systems that, together with LED modules or arrays, comprises an LED lighting device. LED drivers “drive” power to LED modules for optimal light output in different applications and different intensities, with different currents and using different dimming protocols. Many LED lighting systems are programmable, with programmable attributes that may include, but are not limited to, output current, dimming curve, and lowest dimming percentage, thereby allowing the driver to match the output of existing lighting devices or new lighting device designs.

Dimmable LED drivers usually have a dedicated dimming circuit built into them. A dimming driver has two functions: As a driver, it converts the input AC voltage to a low voltage DC output. As a dimmer, i.e., a device for varying the brightness of an electric light, it reduces the amount of electrical energy flowing to the LEDs, thereby causing them to dim. The dimmable driver is typically connected to a dimmer switch to manually control the light output of the device.

### BRIEF DESCRIPTION OF THE DRAWINGS

Reference should be made to the following detailed description which should be read in conjunction with the following figures, wherein like numerals represent like parts.

FIG. 1A is an example of an existing NFC-enabled lighting device.

FIG. 1B is an example of a retrofit NFC-enabled control circuit, consistent with the present disclosure.

FIG. 2 is an example of a device for control of a lighting device using NFC, consistent with the present disclosure.

FIG. 3 is an example of a lighting device with a device for control of a lighting device using NFC installed, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Lighting devices based on LED technology often include the ability to adjust the output brightness of the lighting device. The LED driver incorporated into these lighting devices may include the ability to limit the output current of the LED driver to set the maximum brightness of the lighting device. These LED drivers may also include the ability to brighten or dim the lighting device under the control of a manual dimmer switch. Some of these lighting devices may also include NFC to configure the maximum drive current, typically during manufacturing or at the time of installation. The value of the LED driver software programmability is not fully utilized as it typically is only used for one time programming of the LED driver at the factory.

These lighting devices typically use NFC to control ALO (adjustable light output) using programming of the LED driver. The NFC capability is not typically embedded at the lighting device level. Therefore, it is not accessible from the room side, i.e., it does not help changing Correlated Color Temperature (CCT), which is a measure of light source color appearance defined by the proximity of the light source's chromaticity coordinates to the blackbody locus, intensity, dim-curve (electrical parameter output in response to control signal input), or other features post installation. There exists a need for an LED driver that uses NFC to control features, such as dimming control, post installation.

Disclosed herein is a device for control of an LED driver using NFC that allows a user to adjust these features post installation using an NFC-capable device to control the lighting device during operation. In general, the technology relates to a wireless controller/module (e.g., NFC module) that can be added to a light fixture and used to control the driver therein, such as a 0-10V dimmable driver. The wireless control module can be mounted remotely from the driver and is capable of controlling programmable and non-programmable drivers.

The disclosed dimming circuit is embedded at the lighting device level, and unlike the current lighting devices, is accessible from the room side, i.e., it allows control of features post installation. The disclosed dimming circuit extends the full feature set of the lighting device including, but not limited to, beam (e.g., light distribution pattern, etc.), CCT, intensity, dimming percentage (which may include, for example, a maximum brightness level, minimum brightness level, etc.), dim-curve, thermal foldback (reduction of the LED current due to rising temperature), and scheduling. This allows the disclosed dimming circuit to extract the full potential of the LED driver software programming. It allows for the placement of the NFC tag remote from the LED driver for a flexible lighting device embedded solution.

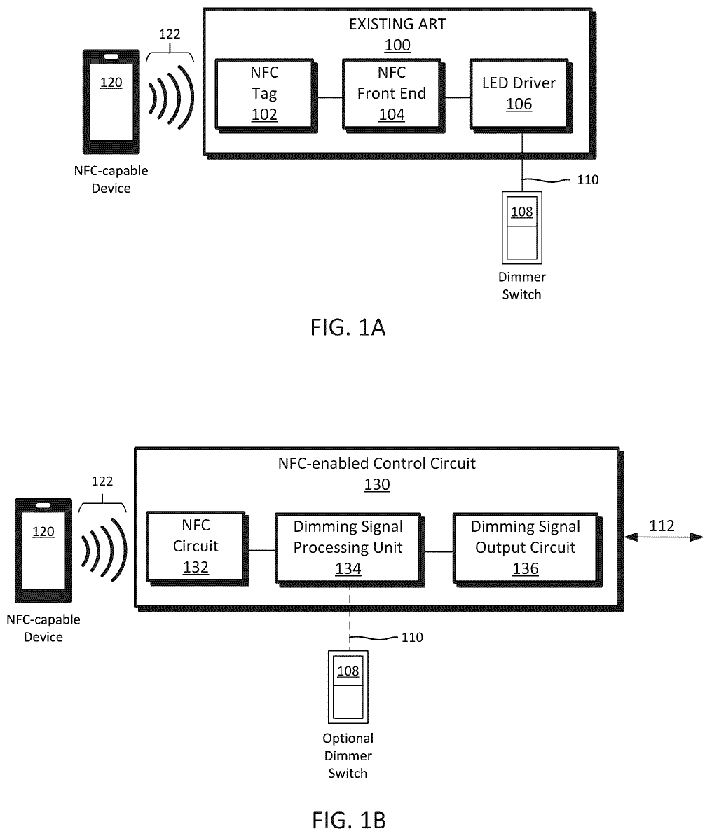

FIG. 1A is an example of a typical existing NFC-enabled lighting device 100. In the example of FIG. 1A, Near field Communication (NFC) tag 102 is communicatively coupled to NFC-capable device 120 via NFC interface 122 that transmits data through electromagnetic radio fields to enable communications between two devices without the need for a physical connection. NFC tag 102 is coupled to NFC front end 104, which is coupled to the LED driver 106. External dimmer switch 108 is coupled to the LED driver 106 of lighting device 100 via dimmer switch interface 110 to allow a user to manually brighten or dim lighting device 100.

As noted above, in the existing NFC-enabled lighting device 100 of FIG. 1A, NFC-capable device 120 communicates with the NFC front end 104 to configure settings in the lighting device 100 prior to installation. Typically, the setting configured by the NFC-capable device 120 is the maximum brightness of the lighting device. For example, NFC-capable device 120 may configure NFC-enabled lighting device 100 to a maximum current output of 50%, thereby limiting the lighting device to half the maximum luminance. The NFC interface in the existing NFC-enabled lighting device 100 does not allow for control of functions of the lighting device, such as brightness, during actual operation of the lighting device.

FIG. 1B is one exemplary illustration of an NFC-enabled control circuit 130 for a typical dimmable LED lighting device. Here NFC circuit 132, like NFC tag 102 from FIG. 1A, is communicatively coupled to NFC-capable device 120 via NFC interface 122. NFC circuit 132 is configured to communicate via a radio frequency (RF) control signal to receive input control signals from the NFC-capable device 120 and/or send status information to the NFC-capable device 120. NFC circuit 132 is also coupled to dimming signal processing unit 134, which is coupled to the dimming signal output circuit 136. The NFC-enabled control circuit 130 is coupled to the typical dimmable LED fixture via control interface 112. This control interface 112 allows for control of the brightness of the LED fixture, as well as control of other parameters, which may include, but are not limited to, output current, dimming curve, and lowest dimming percentage, by sending lighting control signals via control interface 112 to the lighting device.

In this example, NFC-capable device 120 communicates with the dimming signal output circuit 136, via the NFC circuit 132 and the dimming signal processing unit 134, to control the LED driver 106 of the typical dimmable LED fixture. Optionally, an external dimmer switch 108 may be coupled to the dimming signal processing unit 134 of the typical dimmable LED fixture via dimmer switch interface 110 to allow a user to manually brighten or dim lighting device 100.

The NFC-enabled control circuit 130 of FIG. 1B, unlike the NFC-enabled lighting device 100 of FIG. 1A, allows the user of the NFC-capable device 120 to control the lighting device during operation. The user of the NFC-capable device 120 can, for example, brighten or dim the lighting device via the NFC interface 122 directly. This has the same effect as using external dimmer switch 108, but can be used when a dimmer switch is not installed in the lighting circuit, or when the external dimmer switch 108 controls a series of lighting devices, and therefore would cause the entire series of lighting devices to brighten or dim. By the use of the NFC-enabled control circuit 130, each lighting device in the series can be individually adjusted.

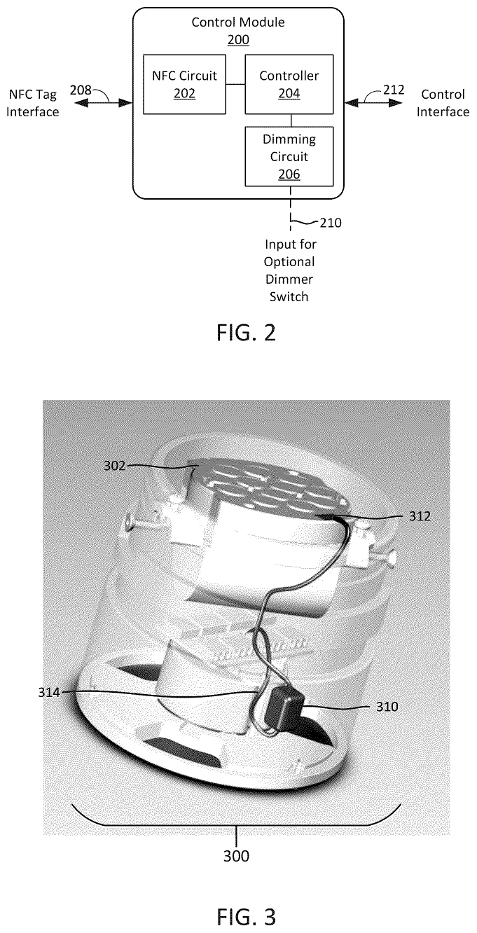

FIG. 2 is an example of an NFC-enabled control module 200, consistent with the present disclosure. In the example of FIG. 2, control module 200 includes NFC circuit 202, which is coupled to an NFC tag via NFC tag interface 208. NFC circuit 202 is also coupled to controller 204 by, for example, an Inter-Integrated Circuit (I2C) interface. In some embodiments, the control module 200 may also include a dimming circuit 206. In such a configuration, the controller 204 is coupled with the dimming circuit 206 and may receive dimming signals from dimming circuit 206 and may send controls to dimming circuit 206. Dimming circuit 206 is also coupled to dimmer switch input 210, which is a connection for an optional manual dimmer switch, such as external dimmer switch 108 from FIGS. 1A and 1B. In other embodiments, the dimming circuit 206 may be omitted, and the controller 204 is configured to exchange commands and data with the control interface 212 (which is coupled to an LED driver circuit associated with the lighting device).

Dimming circuit 206 may be coupled to the lighting device via control interface 212. In some embodiments, control interface 212 may be a two-wire interface consisting of Direct Current (DC) output terminals (e.g., DIM+ and DIM−) for controlling dimming of the lighting device. In other embodiments, control interface 212 may be any appropriate interface to communicate with the lighting device, either unidirectionally or bidirectionally, as would be known to a person of skill in the art.

Control module 200 allows for control of operational features of the lighting device, e.g., dimming and/or brightening the output of the lighting device, using either a smart device connected to the control module 200 via the NFC interface, i.e., through an NFC tag attached to the NFC tag interface 208, or an optional manual dimmer switch, such as external dimmer switch 108 from FIGS. 1A and 1B. Control module 200 may be incorporated into a new lighting device or may be retrofit into an existing lighting device to allow the lighting device to be controlled, e.g., dimmed or brightened, using a smart device and NFC.

FIG. 3 is an example of a lighting device with an NFC-enabled control module installed, consistent with the present disclosure. In the example of FIG. 3, lighting device 300 is ALO capable, including the capability to adjust maximum output current, as well as the ability to dim or brighten under control of a manual dimmer switch. In this lighting device, an NFC-enabled control module, e.g., NFC-enabled control module 200 from FIG. 2, has been installed to allow for NFC control of the lighting device during operation.

The example lighting device 300 of FIG. 3 includes the NFC-enabled control module 310 coupled with the dimming circuit of lighting device 300 via control output 314. The NFC-enabled control module 310 is also coupled with the NFC tag 312. In this example, the NFC tag 312 is mounted on LED module 302 since this module should be easily accessible to a user after the lighting device 300 has been installed. Control output 314 is the interface to the LED driver to allow control of the operational parameters, including, but not limited to, CCT, intensity, dimming percentage, dim-curve, thermal foldback, and scheduling.

It should be noted that the lighting device 300 of FIG. 3 is merely one example use of the NFC-enabled control module. Many other possible uses of the NFC-enabled control module are possible, as would be known to a person of skill in the art. While the foregoing description includes various operations for control of an LED driver using NFC, according to example embodiments consistent with the present disclosure, it is to be understood that not all of the operations depicted are necessary for other embodiments. Indeed, it is fully contemplated herein that in other embodiments of the present disclosure, the example operations described above for control of an LED driver using NFC, and/or other operations described herein, may be combined in a system and method consistent with the present disclosure. Thus, claims directed to features and/or operations that are not exactly shown in one drawing or described in one example are deemed within the scope and content of the present disclosure.

According to one aspect of the disclosure there is thus provided a device for control of a lighting device to permit a user to adjust features of the lighting device, comprising: a near field communication (NFC) circuit configured to communicate via a radio frequency (RF) control signal; and a controller, the controller configured to: receive input control signals from a user via the NFC circuit; and send lighting control signals to the lighting device to control the operation of the lighting device based on, at least in part, the input control signals.

According to another aspect of the disclosure there is thus provided a device for control of a lighting device to permit a user to adjust features of the lighting, comprising: a near field communication (NFC) circuit configured to communicate via a radio frequency (RF) control signal; a dimming circuit; and a controller, the controller configured to: receive input control signals from a user via the NFC circuit; receive dimming signals from the dimming circuit; and send lighting control signals to the lighting device to control the operation of the lighting device based on the input control signals and the dimming signals.

According to yet another aspect of the disclosure there is thus provided a method, the method comprising: receiving input control signals from a user via an NFC circuit; receiving dimming signals from a dimming circuit; and sending lighting control signals to the lighting device based on the input control signals and the dimming signals.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising,” “including,” and “having” are intended to be inclusive and mean that there may be additional elements other than the listed elements.

The present disclosure may be a device, a system, and/or a method. The device, a system, and/or a method may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A device for control of a lighting device to permit a user to adjust features of the lighting device, comprising:
a near field communication (NFC) circuit configured to communicate via a radio frequency (RF) control signal; and
a controller, the controller configured to:
receive input control signals from a user via the NFC circuit; and
send lighting control signals to the lighting device to control the operation of the lighting device based on, at least in part, the input control signals.

2. The device of claim 1, further comprising a dimming circuit, the controller further configured to receive dimming signals from the dimming circuit and send lighting control signals to the lighting device further based on the dimming signals.

3. The device of claim 1, wherein the NFC circuit further comprises:
an NFC tag interface; and
an NFC tag, wherein the NFC tag is communicatively coupled to the NFC tag interface.

4. The device of claim 3, wherein the NFC tag is remote from the NFC circuit.

5. The device of claim 2, wherein the dimming circuit further comprises:
a dimmer switch input, wherein the dimmer switch input is coupled to an external dimmer switch, and wherein the dimmer switch is configured to generate the dimming signals.

6. The device of claim 1, wherein the controller is further configured to:
receive status information from the lighting device; and
send the status information to the user via the NFC circuit.

7. The device of claim 1, wherein the lighting control signals includes at least one of correlated color temperature, beam, intensity, dimming percentage, dim-curve, thermal foldback, and scheduling.

8. The device of claim 1, wherein the device is retroactively installed in the lighting device.

9. The device of claim 1, wherein the lighting device comprises an LED driver circuit.

10. A device for control of a lighting device to permit a user to adjust features of the lighting device, comprising:
a near field communication (NFC) circuit configured to communicate via a radio frequency (RF) control signal;
a dimming circuit; and
a controller, the controller configured to:
receive input control signals from a user via the NFC circuit;
receive dimming signals from the dimming circuit; and
send lighting control signals to the lighting device to control the operation of the lighting device based on the input control signals and the dimming signals.

11. The system of claim 10, wherein the NFC circuit further comprises:
an NFC tag interface; and
an NFC tag, wherein the NFC tag is communicatively coupled to the NFC tag interface.

12. The system of claim 11, wherein the NFC tag is remote from the NFC circuit.

13. The system of claim 10, wherein the controller is further configured to:
receive status information from the lighting device; and
send the status information to the user via the NFC circuit.

14. The system of claim 10, wherein the lighting control signals includes at least one of correlated color temperature, beam intensity, dimming percentage, dim-curve, thermal foldback, and scheduling.

15. The system of claim 10, wherein the NFC-circuit is retroactively installed in the lighting device.

16. A method of controlling a lighting device using Near Field Communications (NFC), the method comprising:
receiving input control signals from a user via an NFC circuit;
receiving dimming signals from a dimming circuit; and
sending lighting control signals to the lighting device based on the input control signals and the dimming signals.

17. The method of claim 16, wherein the NFC circuit comprises:
an NFC tag; and
an NFC tag interface, wherein the NFC tag interface is communicatively coupled to the NFC tag.

18. The method of claim 17, wherein the NFC tag is remote from the NFC circuit.

19. The method of claim 16, wherein the dimming circuit comprises:
a dimmer switch input, wherein the dimmer switch input is coupled to an external dimmer switch.

20. The method of claim 16 further comprising:
receive status information from the lighting device; and
send the status information to the user via the NFC circuit.

21. The method of claim 16, wherein the lighting control signals includes at least one of correlated color temperature, intensity, dimming percentage, dim-curve, thermal foldback, and scheduling.

22. The method of claim 16, further comprising a controller and one or more program instructions, wherein the one or more program instructions are stored on a non-transitory computer readable storage media.
